(19) United States
(12) Patent Application Publication
(10) Pub. No.: US 2002/0063741 A1
(43) Pub. Date: May 30, 2002

(54) Process for rendering pre-existing information accessible to individuals suffering from visual and/or auditory deficiencies

(76) Inventors: Francis Cousin, Poitiers (FR); Michel Grellier, Poitiers (FR)

Correspondence Address: YOUNG & THOMPSON, 745 SOUTH 23RD STREET 2ND FLOOR, ARLINGTON, VA, 22202

(21) Appl. No.: 09/984,732

(22) Filed: Oct. 31, 2001

(30) Foreign Application Priority Data
Oct. 31, 2000 (FR) 00 14026

(51) Int. Cl. G09G 5/00

(52) U.S. Cl. 345/865

(57) ABSTRACT

This process for rendering pre-existing information (58), adapted to be reproduced by an electronic information reproduction system, accessible to individuals suffering from visual and/or auditory deficiencies is characterized in that it comprises the following steps:

creation by an operator of a modified form (64) of the pre-existing information, this modified form being perceivable by the said individuals; and

association with the pre-existing information, in the said reproduction system, of its modified form in such a way as to allow the said individuals to access the information through its modified form.

The present invention relates to a process for rendering pre-existing information, adapted to be reproduced by an electronic information reproduction system, accessible to individuals suffering from visual and/or auditory deficiencies and more particularly to a process for rendering pre-existing information from an Internet site accessible.

There are at present processes for creating Internet sites specially designed to be accessible to individuals suffering from visual deficiency. In the subsequent description, individuals suffering from visual deficiency are termed “visually impaired”.

These processes comprise the following steps of:

creation of the information to be presented, then

creation by an operator of reproductions of this information perceivable by the visually impaired, then

transfer of these reproductions of information to a server linked to the worldwide web.

The step of creating the reproductions of information consists in creating a file for each reproduction of information with the aid of a microcomputer. This file comprises information to be presented and instructions defining its form in the reproduction. This information and these instructions form the code of a corresponding reproduction of information.

The instructions used are for example instructions of the HTML (“Hypertext Markup Language”) language which make it possible to determine the visual characteristics of the reproduction of information.

In the known processes, the operator can use only text to present the information.

Moreover, the instructions, for example of the HTML language, are chosen so that the text appears only as black-coloured characters on a white-coloured background.

This characteristic regarding the characters used is imposed by conventional means of converting information present on a microcomputer screen into information directly perceivable by the visually impaired.

These means are for example composed of speech synthesizers and Braille-character terminals.

The existing speech synthesizers convert only the text composed of black-coloured characters on a white-coloured background into messages audible to the visually impaired.

The existing Braille-character terminals convert only this same text into a text composed of Braille characters.

Thus, with the aid of a microcomputer equipped for example with the above means, the visually impaired can consult the information of an Internet site produced specially for them.

The known processes therefore entail creating reproductions of information specially designed for individuals suffering from visual deficiency and, consequently, exhibiting very unsatisfactory ergonomics in respect of other persons.

It is then appreciated that simultaneous consultation by a person suffering from visual deficiency and by a person not suffering therefrom is difficult.

Moreover, the known processes are not capable of satisfactorily rendering pre-existing information, which was not initially produced for them, accessible to persons suffering from visual deficiency.

This problem is encountered in particular in the case of reproductions of information emanating from Internet sites which comprise hypertext links.

A hypertext link is defined in the present description as a means of access from a first item of information to a second item of information.

When a hypertext link is actuated, for example with the aid of a microcomputer mouse, the second item of information becomes accessible, that is to say, for example, visible on a display device.

The known processes of Internet site creation for the visually impaired do not make it possible for hypertext links to be indicated to them, since these links are usually indicated by underlined parts of coloured text.

The present invention therefore aims to remedy the drawbacks of the known processes by proposing a process making it possible for pre-existing information to be easily and rapidly rendered accessible to individuals suffering from visual deficiency.

Its subject is therefore a process for rendering pre-existing information, adapted to be reproduced by an electronic information reproduction system, accessible to individuals suffering from visual and/or auditory deficiencies, characterized in that it comprises the following steps:

creation by an operator of a modified form of the pre-existing information, this modified form being perceivable by the said individuals; and

association with the pre-existing information, in the said reproduction system, of its modified form in such a way as to allow the said individuals to access the information through its modified form.

According to other characteristics of the invention:

the step of associating with the pre-existing information its modified form furthermore consists in simultaneously reproducing the pre-existing information and its modified form in the said information reproduction system,

the step of associating with the pre-existing information its modified form furthermore consists in creating means of access, perceivable by the individuals, to the modified forms of the pre-existing information and in simultaneously reproducing the pre-existing information and these means of access in the said information reproduction system,

the step of creating a modified form of the pre-existing information furthermore comprises the steps of creation of a double of the pre-existing information, then modification of the pre-existing information or of its double so as to create its modified form,

the said electronic information reproduction system comprises an electronic display device and the said individuals suffer from visual deficiency,

the step of creating a modified form of the pre-existing information furthermore comprises the step of creating a legend for the pre-existing visual information with the aid of characters perceivable by the individuals suffering from visual deficiency,

the said perceivable characters are black-coloured characters on a white-coloured background,

the said characters perceivable by the individuals suffering from visual deficiency are adapted so as to be converted with the aid of means of conversion into information directly perceivable by the said individuals,

the said characters perceivable by the individuals suffering from visual deficiency are characters enlarged so as to be directly readable by individuals suffering from visual deficiency,

the said step of creating a legend furthermore comprises the step of supplementing this legend with at least one pictogram perceivable by the individuals suffering from visual deficiency and intended to indicate to them that the legend also forms a means of access to a modified form of the information,

the said electronic information reproduction system comprises audiophonic means and the said individuals suffer from auditory deficiency,

the step of creating a modified form of the pre-existing information furthermore comprises the step of creating a legend for the pre-existing auditory information with the aid of characters perceivable by the individuals suffering from auditory deficiency,

the pre-existing information is information obtained from an Internet site,

the said pre-existing information and its modified form are produced with the aid of the HTML language.

The invention will be better understood on reading the description which follows, given merely by way of example and with reference to the appended drawings in which:

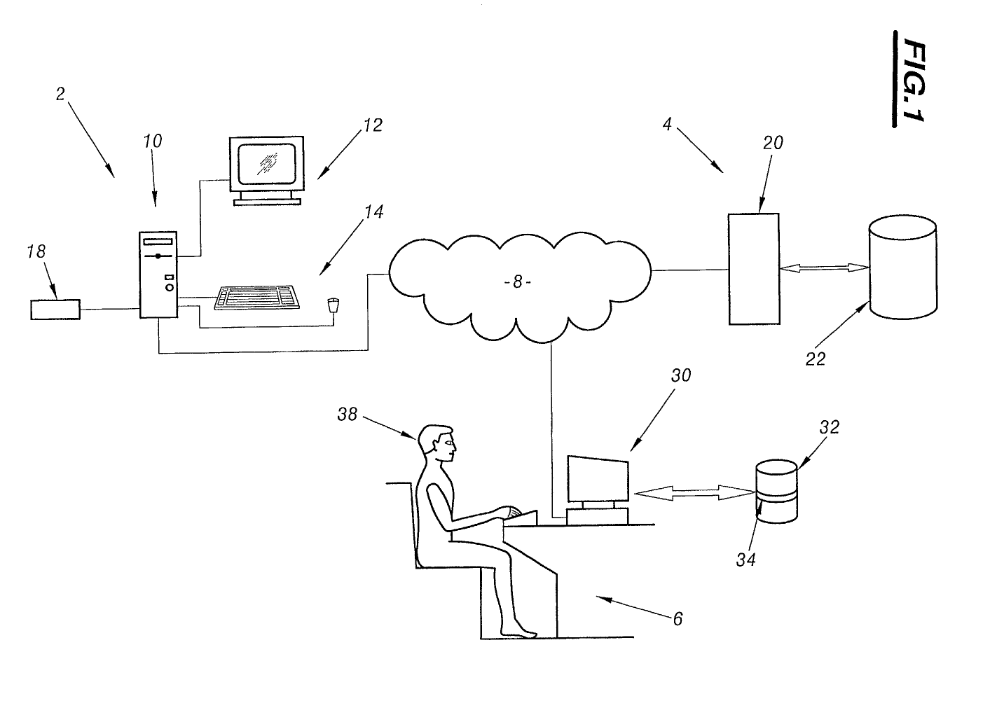

FIG. 1 represents a conventional system for modifying and updating reproductions of information from an Internet site.

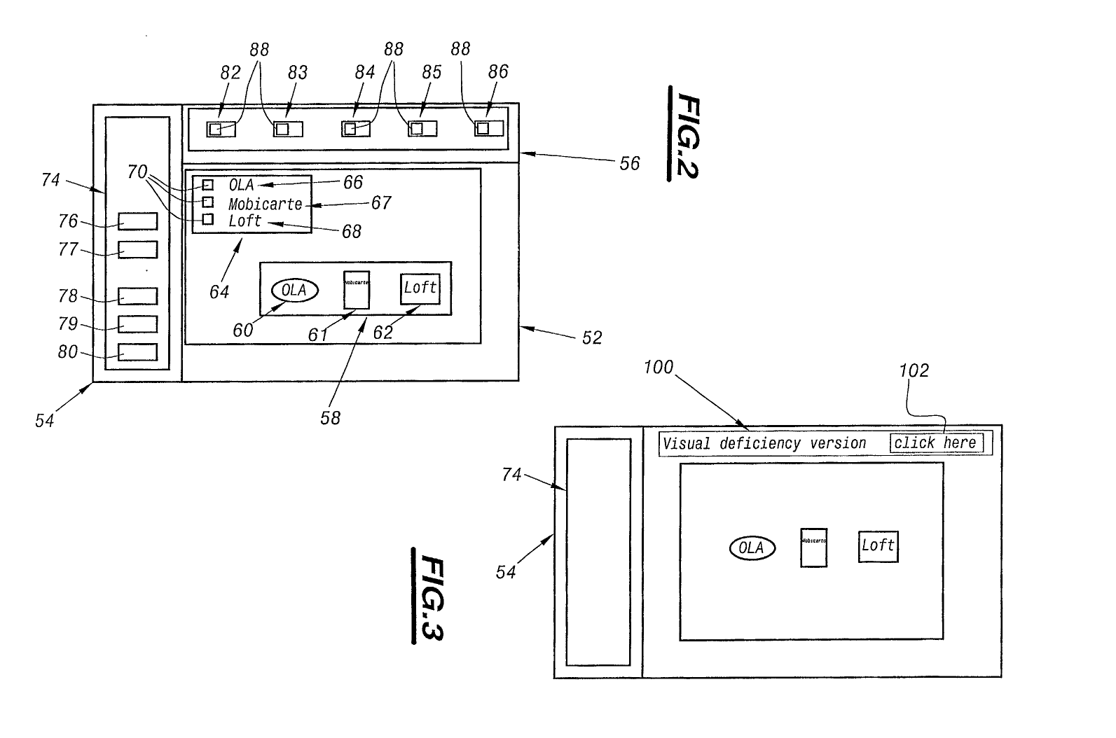

FIGS. 2 and 3 represent examples of information which emanates from an Internet site and is associated with its modified form so as to be rendered accessible to the visually impaired and to the sighted with the aid of the process according to the invention.

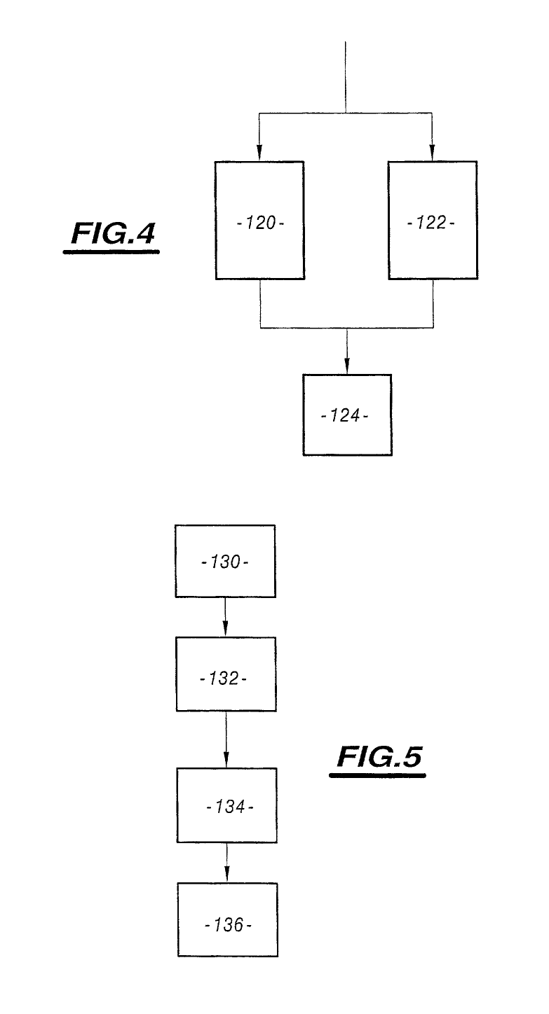

FIGS. 4 and 5 represent two processes according to the invention.

FIG. 1 illustrates a system which comprises three assemblies 2, 4 and 6 hooked up to an information transmission network 8 formed by the worldwide web.

The assembly 2 is composed of a microcomputer 10 equipped with an electronic information reproduction system 12, for example a conventional screen, and with information acquisition means 14 for example a keyboard and/or a mouse.

The system 12 can also comprise audiophonic means, such as loudspeakers associated with a sound card, which are intended to convert auditory information presented in digital form into sound signals.

The electronic information reproduction system 12 and the information acquisition means 14 are intended to be used by a person not suffering from visual deficiency so as to consult Internet sites.

The microcomputer 10 is also equipped with means 18 of converting information present on the system 12 into information directly perceivable by the visually impaired.

These means 18 are composed for example of a conventional speech synthesizer and of a conventional Braille terminal.

The assembly 4 comprises an Internet server 20 hooked up to the network 8. The server 20 comprises means 22 of storage of information accessible through the network 8 to any individual equipped with a microcomputer, such as the microcomputer 10.

The assembly 6 is composed of a microcomputer 30 equipped with information storage means 32. The information storage means 32 store files 34 each containing the code of reproductions of information of a pre-existing Internet site, that is to say of a site whose information has not yet been rendered accessible to the visually impaired with the aid of the process according to the invention. The reproductions of information of a pre-existing site and the information which they contain are subsequently referred to respectively as pre-existing reproductions and pre-existing information.

The microcomputer 30 is also equipped with conventional text editing software and with conventional file transfer software.

The text editing software allows an operator 38 to edit the files 34 and to modify the code of the pre-existing information reproductions which they contain. The file transfer software, such as for example the FTP software, allows the operator 38 to transfer the files 34 to the server 20 and then to store them in the latter's information storage means 22.

Such an architecture therefore allows the operator 38 to modify the reproductions of information of an Internet site.

FIG. 2 represents pre-existing information which emanates from an Internet site and is associated with its modified form so as to be rendered accessible both to the sighted and to the visually impaired.

This reproduction of information is composed of three display areas 52, 54 and 56.

The display area 52 comprises pre-existing information 58, that is to say information which existed in a file such as the file 34 before a process according to the invention is applied.

This pre-existing information 58 is composed of three images 60, 61 and 62. Each image 60, 61 and 62 is a hypertext link to other pre-existing information.

The display area 52 also comprises a modified form 64 of the pre-existing information 58 so that this form is perceivable by the visually impaired with the aid of conversion means such as the conversion means 18 of FIG. 1.

The modified form 64 of the information is composed of left-justified text. The text comprises three legends 66, 67 and 68 each corresponding respectively to a modified form of the pre-existing information 60, 61 and 62.

The legends 66, 67 and 68 are composed of black-coloured characters on a white-coloured background and of a pictogram 70 intended to indicate to the visually impaired that the legend is also a hypertext link. The legends 66, 67 and 68 each return to modified forms of information.

The display area 54 comprises a plan 74 of an Internet site.

The plan 74 is composed of five hypertext links 76 to 80 which return to pre-existing information.

The plan 74 is not modified so as to be perceivable by the visually impaired. It is therefore intended to be used by the sighted wishing to consult only pre-existing information of the Internet site, that is to say in a form not adapted to consultation by the visually impaired.

The display area 56 comprises a modified form of the hypertext links 76 to 80 so as to be perceivable by the visually impaired.

This modified form is composed of five legends 82, 83, 84, 85 and 86. Each of these legends is formed of black-coloured characters on a white-coloured background, and also comprises a pictogram 88 intended to indicate to the visually impaired that this is a hypertext link. Each of these hypertext links returns to a modified form of the pre-existing information so as to be perceivable by the visually impaired.

FIG. 3 represents an example of associating pre-existing information with its modified form so as to be rendered accessible to the visually impaired.

It comprises a means of access 100 to a modified form of the pre-existing information so as to be perceivable by the visually impaired. The means of access 100 is formed by a legend forming a hypertext link. The legend is composed of black-coloured characters on a white-coloured background and of a pictogram 102 for indicating to the visually impaired that this is a hypertext link.

The manner of operation of the process for rendering pre-existing information, adapted to be reproduced by an electronic information reproduction system, accessible to individuals suffering from visual deficiency will now be described in regard to FIG. 4 and in the particular case where the pre-existing information is that of an Internet site.

The process is composed of three main steps 120, 122, 124 carried out by an operator such as the operator 38:

a first step 120 of creating a modified form of the pre-existing information of the Internet site so that this information is perceivable by the visually impaired,

a second step 122 of associating with the pre-existing information its modified form in such a way as to allow the individuals suffering from visual deficiency to access the information through its modified form, and

a third step 124 of transferring modified files from the Internet site to a server such as the server 20.

These first two steps may be executed in any order by the operator, including simultaneously.

In a first mode of carrying out the process according to the invention, the first and the second steps 120, 122 are carried out simultaneously. They consist in editing with the aid of a conventional text editor each of the pre-existing files 34 of the Internet site and in supplementing these files with for example instructions of the HTML language, so as to create and add a modified form of the pre-existing information so that the latter is perceivable by visually impaired users.

More precisely, the step of creating the modified form of the pre-existing information consists in creating legends as black-coloured characters on a white-coloured background and associated with each image, text or pre-existing hypertext link. The operator also supplements the legend of hypertext links with a pictogram perceivable by the visually impaired so as to indicate to them that this is a hypertext link.

For example, the supplementary pictogram added for each legend of a hypertext link is a digit and preferably the digit is different for each legend of a hypertext link so as to aid the visually impaired to identify and store the latter.

The hypertext links created and added return to modified forms of the pre-existing information.

Finally, when the operator has carried out the first and the second steps 120, 122 for the set of files 34 of the Internet site, he transfers, during the third step 124, these modified files to an Internet server such as the server 20 of FIG. 1 where they are stored in a conventional manner in the information storage means such as the means 22 of the server 20.

It will be noted that the code corresponding to the modified form of the information is added to the file already containing the code corresponding to the reproduction of pre-existing information and that, consequently, the pre-existing information and its modified form are associated in one and the same reproduction of information as and when they are created.

It will also be observed that the Internet site obtained after applying the first mode of carrying out the process according to the invention is consultable simultaneously by the sighted and the visually impaired using one and the same microcomputer, such as the microcomputer 10 of FIG. 1.

Other modes of carrying out the invention may be envisaged.

Thus, according to a second mode of carrying out a process according to the invention illustrated at FIG. 5, the process comprises four main steps:

a first step 130 of creating a double of the pre-existing information, then

a second step 132 of creating the modified forms of the pre-existing information,

a third step 134 of associating the modified form of the information with the pre-existing information, and

a fourth step 136 of transferring the files containing the modified forms of the information of the Internet site to an Internet server such as the server 20 of FIG. 1.

The first step 130 consists in creating a double of each pre-existing file such as the files 34 with the aid of conventional operations of file copying on a microcomputer.

The second step 132 consists in editing and in modifying with the aid of a conventional text editor each of the doubles of the pre-existing files 34 previously created and then in creating and in adding a modified form of the pre-existing information for each file.

This step is similar to the first and to the second steps 120, 122 of the first mode of carrying out the process according to the invention. This step will therefore not be described in greater detail.

The third step 134 consists in editing a pre-existing file of the Internet site and then in creating and in adding to this file at least one means of access, such as the hypertext link 100 of FIG. 3, to the modified forms of the pre-existing information created during the second step.

No further modification is made to this edited pre-existing file.

Preferably, the edited pre-existing file will be the home page of the pre-existing Internet site.

The fourth step 136 of transferring the modified files to an Internet server is similar to the third step 124 of the first mode of carrying out the process according to the invention. This step will therefore not be described in greater detail.

Thus, according to the second mode of carrying out the process according to the invention, an Internet site is obtained wherein the sighted user may choose to consult the pre-existing version of the Internet site, with the aid of the pre-existing plan such as the plan 74 of FIG. 3, whilst the visually impaired, by using a hypertext link such as the hypertext link 100 of FIG. 3, may choose to consult a double of the site rendered accessible simultaneously to the sighted and to the visually impaired using one and the same microcomputer, such as the microcomputer 10 of FIG. 1.

In a variant of the second mode of carrying out the above-described process according to the invention, the second step described previously is replaced by a step which consists not in supplementing the pre-existing information with a modified form thereof, but in replacing this pre-existing information with its modified form so as to be perceivable by the visually impaired.

The other steps of the second mode of carrying out the process according to the invention remain unchanged.

It will be noted that an Internet site is thus obtained which is intended to be consulted in succession by the sighted and the visually impaired and is no longer intended to be consulted simultaneously.

In another variant of the second mode of carrying out the process according to the invention, the third step is replaced by a step which consists in adding, with the aid of conventional programming operations, a display area such as the area 56 of FIG. 2 which coexists on the same display device with the pre-existing display areas of the Internet site, such as for example the areas 52 and 54 of FIG. 2.

This added viewing area is intended to contain a modified form of the pre-existing information.

Preferably, this added viewing area contains a modified form of the plan of the Internet site such as the plan 74 of FIG. 2. This yields pre-existing information associated with its modified form in independent viewing areas. It will be noted that, in this variant, the step of associating a modified form with the pre-existing form follows the step of creating the modified form.

It will be noted that the various modes of carrying out the above-described process according to the invention may be combined into one and the same process and applied to one and the same Internet site.

It will also be observed that the modified form of the pre-existing information may be produced with the aid of characters sufficiently enlarged as to be directly perceivable by individuals suffering from slight visual deficiency.

The process described in the particular case of the visually impaired and of an Internet site can also be used to render an Internet site accessible to the hearing impaired.

In this case, the steps of creating a modified form of the pre-existing information consist in transcribing the pre-existing auditory information into a form of text readable by the hearing impaired.

1. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form, and
in that the step of creating a modified form of the pre-existing information furthermore comprises a step of creating a legend with the aid of characters perceivable by the said individuals suffering from visual and/or auditory deficiencies.

2. Process according to claim 1, characterized in that the step of associating with the pre-existing information its modified form furthermore consists in simultaneously reproducing the pre-existing information (58) and its modified form (64) in the said information reproduction system.

3. Process according to claim 1, characterized in that the step of associating with the pre-existing information its modified form furthermore consists in creating means of access (100), perceivable by the individuals, to the modified forms of the pre-existing information and in simultaneously reproducing the pre-existing information and these means of access in the said information reproduction system (12).

4. Process according to claim 1, characterized in that the step of creating a modified form (64) of the pre-existing information furthermore comprises the steps of:
creation (130) of a double of the pre-existing information, then
modification (132) of the pre-existing information or of its double so as to create its modified form.

5. Process according claim 1, characterized in that the said electronic information reproduction system (12) comprises an electronic display device and in that the said individuals suffer from visual deficiency.

6. Process according to claim 5, characterized in that the step of creating a legend for the pre-existing visual information comprises the step of creating this legend with the aid of characters perceivable by the individuals suffering from visual deficiency.

7. Process according to claim 6, characterized in that the said characters perceivable by the individuals suffering from visual deficiency are adapted so as to be converted with the aid of means (18) of conversion into information directly perceivable by the said individuals.

8. Process according to claim 7, characterized in that the said perceivable characters are black-coloured characters on a white-coloured background.

9. Process according to claim 6, characterized in that the said characters perceivable by the individuals suffering from visual deficiency are characters enlarged so as to be directly readable by individuals suffering from visual deficiency.

10. Process according to claim 6, characterized in that the said step of creating a legend furthermore comprises the step of supplementing this legend with at least one pictogram (70, 88) perceivable by the individuals suffering from visual deficiency and intended to indicate to them that the legend also forms a means of access to a modified form of the information.

11. Process according to claim 10, characterized in that the pre-existing information is information obtained from an Internet site.

12. Process according to claim 11, characterized in that the said pre-existing information and its modified form are produced with the aid of the HTML language.

13. Process according to claim 1, characterized in that the said electronic information reproduction system (12) comprises audiophonic means and in that the said individuals suffer from auditory deficiency.

14. Process according to claim 11, characterized in that the step of creating a modified form of the pre-existing information furthermore comprises the step of creating a legend for the pre-existing auditory information with the aid of characters perceivable by the individuals suffering from auditory deficiency.

15. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies, and
in that the step of associating with the pre-existing information its modified form furthermore consists in simultaneously reproducing the pre-existing information (58) and its modified form (64) in the said information reproduction system.

16. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies, and
in that the step of associating with the pre-existing information its modified form furthermore consists in creating means of access (100), perceivable by the individuals, to the modified forms of the pre-existing information and in simultaneously reproducing the pre-existing information and these means of access in the said information reproduction system (12).

17. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies,
in that the step of associating with the pre-existing information its modified form furthermore consists in simultaneously reproducing the pre-existing information (58) and its modified form (64) in the said information reproduction system,
in that the said electronic information reproduction system (12) comprises an electronic display device and in that the said individuals suffer from visual deficiency,
in that the step of creating a legend for the pre-existing visual information comprises the step of creating this legend with the aid of characters perceivable by the individuals suffering from visual deficiency, and
in that the said characters perceivable by the individuals suffering from visual deficiency are adapted so as to be converted with the aid of means (18) of conversion into information directly perceivable by the said individuals.

18. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies,
in that the step of associating with the pre-existing information its modified form furthermore consists in creating means of access (100), perceivable by the individuals, to the modified forms of the pre-existing information and in simultaneously reproducing the pre-existing information and these means of access in the said information reproduction system (12),
in that the said electronic information reproduction system (12) comprises an electronic display device and in that the said individuals suffer from visual deficiency,
in that the step of creating a legend for the pre-existing visual information comprises the step of creating this legend with the aid of characters perceivable by the individuals suffering from visual deficiency, and
in that the said characters perceivable by the individuals suffering from visual deficiency are adapted so as to be converted with the aid of means (18) of conversion into information directly perceivable by the said individuals.

19. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies,
in that the step of associating with the pre-existing information its modified form furthermore consists in simultaneously reproducing the pre-existing information (58) and its modified form (64) in the said information reproduction system,
in that the said electronic information reproduction system (12) comprises an electronic display device and in that the said individuals suffer from visual deficiency, and
in that the step of creating a legend for the pre-existing visual information comprises the step of creating this legend with the aid of characters perceivable by the individuals suffering from visual deficiency,
in that the said characters perceivable by the individuals suffering from visual deficiency are characters enlarged so as to be directly readable by individuals suffering from visual deficiency.

20. Process for rendering pre-existing information (58), adapted to be reproduced by an electronic information reproduction system (12) accessible to individuals suffering from visual and/or auditory deficiencies for, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies,
in that the step of associating with the pre-existing information its modified form furthermore consists in creating means of access (100), perceivable by the individuals, to the modified forms of the pre-existing information and in simultaneously reproducing the pre-existing information and these means of access in the said information reproduction system (12),
in that the said electronic information reproduction system (12) comprises an electronic display device and in that the said individuals suffer from visual deficiency,
in that the step of creating a legend for the pre-existing visual information comprises the step of creating this legend with the aid of characters perceivable by the individuals suffering from visual deficiency, and
in that the said characters perceivable by the individuals suffering from visual deficiency are characters enlarged so as to be directly readable by individuals suffering from visual deficiency.

21. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies,
in that the step of associating with the pre-existing information its modified form furthermore consists in simultaneously reproducing the pre-existing information (58) and its modified form (64) in the said information reproduction system,
in that the said electronic information reproduction system (12) comprises an electronic display device and in that the said individuals suffer from visual deficiency,
in that the step of creating a legend for the pre-existing visual information comprises the step of creating this legend with the aid of characters perceivable by the individuals suffering from visual deficiency,
in that the said characters perceivable by the individuals suffering from visual deficiency are adapted so as to be converted with the aid of means (18) of conversion into information directly perceivable by the said individuals, and
in that the said step of creating a legend furthermore comprises the step of supplementing this legend with at least one pictogram (70, 88) perceivable by the individuals suffering from visual deficiency and intended to indicate to them that the legend also forms a means of access to a modified form of the information.

22. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies,
in that the step of associating with the pre-existing information its modified form furthermore consists in creating means of access (100), perceivable by the individuals, to the modified forms of the pre-existing information and in simultaneously reproducing the pre-existing information and these means of access in the said information reproduction system (12),
in that the said electronic information reproduction system (12) comprises an electronic display device and in that the said individuals suffer from visual deficiency,
in that the step of creating a legend for the pre-existing visual information comprises the step of creating this legend with the aid of characters perceivable by the individuals suffering from visual deficiency,
in that the said characters perceivable by the individuals suffering from visual deficiency are adapted so as to be converted with the aid of means (18) of conversion into information directly perceivable by the said individuals, and
in that the said step of creating a legend furthermore comprises the step of supplementing this legend with at least one pictogram (70, 88) perceivable by the individuals suffering from visual deficiency and intended to indicate to them that the legend also forms a means of access to a modified form of the information.

23. Process for rendering pre-existing information (58), adapted to be reproduced by an electronic information reproduction system (12), accessible to individuals suffering from visual and/or auditory deficiencies, characterized in that it comprises the following steps:
creation (120) by an operator of a modified form (64) of the pre-existing information, this modified form being perceivable by the said individuals; and
association (122) with the pre-existing information, in the said reproduction system, of its modified form in such a way as to allow the said individuals to access the information through its modified form,
in that the step of creating a modified form of the pre-existing information furthermore comprises a step of creating a legend with the aid of characters perceivable by the said individuals suffering from visual and/or auditory deficiencies,
in that the said electronic information reproduction system (12) comprises audiophonic means and in that the said individuals suffer from auditory deficiency, and
in that the step of creating a modified form of the pre-existing information furthermore comprises the step of creating a legend for the pre-existing auditory information with the aid of characters perceivable by the individuals suffering from auditory deficiency.
